(19) United States
(12) Patent Application Publication
(10) Pub. No.: US 2009/0292806 A1
(43) Pub. Date: Nov. 26, 2009

(54) Management of Remotely Hosted Services

(75) Inventors: Adam C. DePue, Redmond, WA (US); Paul R. Fitzgerald, Woodinville, WA (US); Kevin T. Kean, Woodinville, WA (US); Neil Fishman, Redmond, WA (US); Sean D. Daniel, Redmond, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/125,899

(22) Filed: May 22, 2008

(51) Int. Cl. G06F 15/173; G06F 21/20

(52) U.S. Cl. 709/225; 726/6

(57) ABSTRACT

A management system for remote services may use an administrative server within a local area network to manage the remote services for many manageable entities. The administrative server may connect to a clearinghouse server outside the local area network to obtain information about available remote services and to consolidate some operations for interfacing to the remote services. In some embodiments, the clearinghouse server may act as a proxy for many different remote services and may enable some functions to be aggregated across different remote services, such as billing, authentication, provisioning, and other functions. The administrative server may configure the managed entities to access the remote services as well as other functions.

### BACKGROUND

Many different services may be offered from remotely hosted services. Examples of remotely hosted services are ‘web services’ that may provide various functions such as accounting, customer management, or other functionality. In some cases, applications that could operate on a local system may be offered as a remotely hosted service. For example, a word processing program may be available as a locally executing application or as a remotely hosted web service.

As more and more remote services become available, the administration of those services can become extremely complex in an enterprise environment where many different users and many different computer systems may exist.

### SUMMARY

A management system for remote services may use an administrative server within a local area network to manage the remote services for many manageable entities. The administrative server may connect to a clearinghouse server outside the local area network to obtain information about available remote services and to consolidate some operations for interfacing to the remote services. In some embodiments, the clearinghouse server may act as a proxy for many different remote services and may enable some functions to be aggregated across different remote services, such as billing, authentication, provisioning, and other functions. The administrative server may configure the managed entities to access the remote services as well as other functions.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings,

FIG. 1 is a diagram illustration of an embodiment showing a system with a clearinghouse server.

FIG. 2 is a flowchart illustration of an embodiment showing a method for operation of an administrative server.

FIG. 3 is a flowchart illustration of an embodiment showing a method for receiving installation information.

FIG. 4 is a flowchart illustration of an embodiment showing a method for client access to a remote service.

FIG. 5 is a flowchart illustration of an embodiment showing a method for registering a remote service with a clearinghouse server.

FIG. 6 is a flowchart illustration of an embodiment showing a method for establishing a relationship between a clearinghouse server and administrative servers.

FIG. 7 is a flowchart illustration of an embodiment showing a method for actions that may be taken by a clearinghouse server to configure a new client.

FIG. 8 is a flowchart illustration of an embodiment showing a method for proxy operations that may be performed by a clearinghouse server.

### DETAILED DESCRIPTION

Remote services may be administered and managed using a clearinghouse server and administrative servers. A clearinghouse server may aggregate many remote services and enable a common interface for administration, provisioning, authentication, billing, licensing, and other functions. An administrative server may manage a group of remote services for a group of managed entities such as devices or users. In a typical embodiment, an administrative server may manage devices or users within a local area network.

The administrative server may establish a common mechanism for administering many diverse remote services by using the clearinghouse server. For example, a single license or billing mechanism may be established between an administrative server and a clearinghouse server. Such an arrangement may enable many clients to access diverse remote services that may be provided from different service providers with different billing and licensing systems, yet the administrator may receive a single invoice and manage a single licensing agreement.

In some cases, the clearinghouse server may serve as an intermediary or proxy between a client and a remote service. In some proxy arrangements, a clearinghouse server may function as an authentication proxy to establish an authenticated session between a client and a remote service. In other proxy arrangements, the clearinghouse server may provide communication protocol translation, forwarding, or other services.

The clearinghouse server may enable many different and diverse remote services to be effectively managed, marketed, and operated. Each remote service may be provided by a different company or service provider, each of which may have different mechanisms for billing, usage, authentication, protocols, and other incompatibilities. The clearinghouse server may establish individual relationships with the various service providers and present a consolidated mechanism to various subscribers or users of the remote services.

The consolidated mechanism may be administered through a local administrative server that may provision various clients and manage the client connections to the remote services.

Throughout this specification, like reference numbers signify the same elements throughout the description of the figures.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

The subject matter may be embodied as devices, systems, methods, and/or computer program products. Accordingly, some or all of the subject matter may be embodied in hardware and/or in software (including firmware, resident software, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. By way of example, and not limitation, computer readable media may comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by an instruction execution system. Note that the computer-usable or computer-readable medium could be paper or another suitable medium upon which the program is printed, as the program can be electronically captured, via, for instance, optical scanning of the paper or other medium, then compiled, interpreted, of otherwise processed in a suitable manner, if necessary, and then stored in a computer memory.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

When the subject matter is embodied in the general context of computer-executable instructions, the embodiment may comprise program modules, executed by one or more systems, computers, or other devices. Generally, program modules include routines, programs, objects, components, data structures, etc. that perform particular tasks or implement particular abstract data types. Typically, the functionality of the program modules may be combined or distributed as desired in various embodiments.

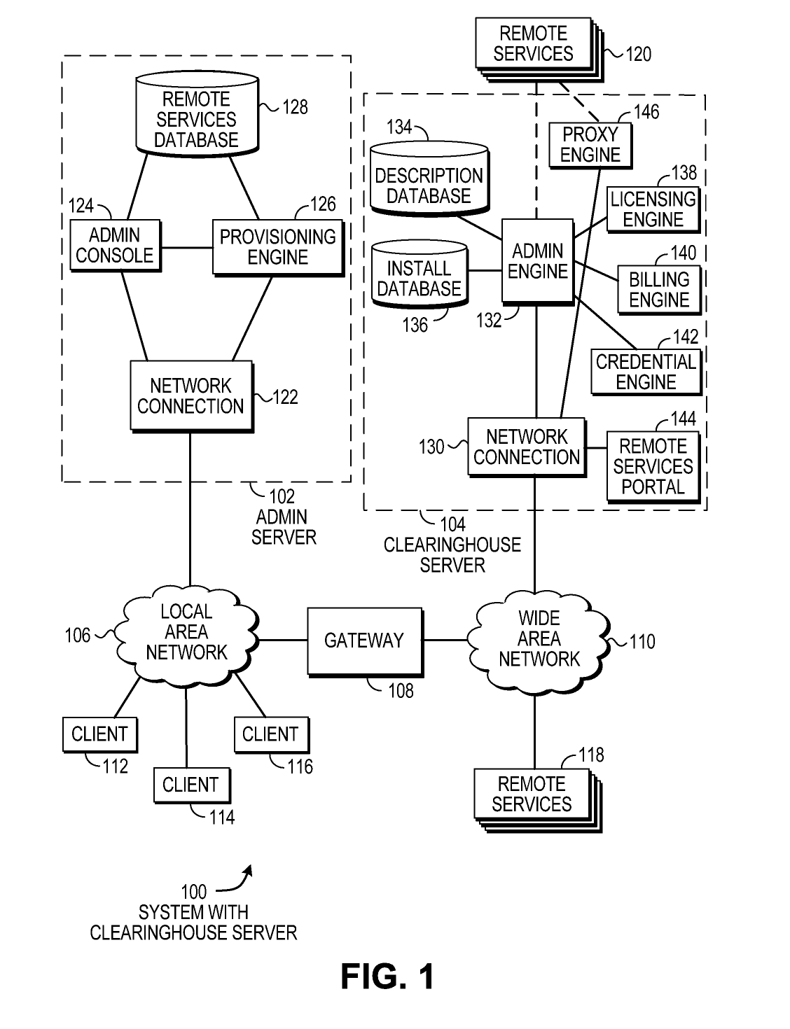

FIG. 1 is a diagram of an embodiment 100 showing a system for managing remote services using a clearinghouse server. Embodiment 100 is a simplified example of a system that consolidates several remote services and makes those services available through a clearinghouse server. An administrative server may manage the remote services for multiple client devices.

The diagram of FIG. 1 illustrates functional components of a system. In some cases, the component may be a hardware component, a software component, or a combination of hardware and software. Some of the components may be application level software, while other components may be operating system level components. In some cases, the connection of one component to another may be a close connection where two or more components are operating on a single hardware platform. In other cases, the connections may be made over network connections spanning long distances. Each embodiment may use different hardware, software, and interconnection architectures to achieve the functions described.

Embodiment 100 is an example of a system that may use both a clearinghouse server 104 and an administrative server 102 to manage and administer multiple remote services. The clearinghouse server 104 may consolidate many administrative functions from multiple remote services 118 and 120 and enable the administrative server 102 to administer those services to various clients.

The administrative server 102 may connect to the clearinghouse server 104 through a local area network 106, to a gateway 108, and through a wide area network 110. The wide area network 110 may be any type of network and may include portions of the Internet.

In many embodiments, the administrative server 102 may manage various clients 112, 114, and 116 within a local area network 106. A typical embodiment may be a network operated within a company, a person's home, or some other entity. In some embodiments, the administrative server 102 may provide many other services across the local area network 106, such as file sharing, authentication, or other services.

In some embodiments, the clients 112, 114, and 116 may be various types of computers, such as laptop computers, desktop computers, workstations, server computers, or other devices. In some embodiments, the clients 112, 114, and 116 may be portable devices such as mobile phones, handheld scanners, or other devices. The clients 112, 114, and 116 may be any device through which a remote service may be accessed or utilized.

The administrative server 102 may be configured to manage any type of client or managed entity, which may be a user, device, or combination of a user and a device. When a device is a client or managed entity, a particular device may be provisioned to access a remote service. When a user is a client or managed entity, each user account may be separately provisioned, which may involve provisioning some devices.

For the purposes of this specification and claims, the terms “managed entity” and “client” are used interchangeably.

In some embodiments, the functions of the administrative server 102 may be performed by any device. For example, the functions of the administrative server 102 may be performed on a laptop computer or desktop computer. In some embodiments, the functions of the administrative server 102 may be performed by a dedicated device.

Embodiment 100 illustrates the functions of an administrative server 102 as being located within the local area network 106. In other embodiments, the functions of the administrative server 102 may be contained in a device connected to the wide area network 110, and the administrative server 102 may be accessible from the local area network 106. In some embodiments, the functions of the administrative server 102 may be performed on the same hardware platform as the functions of the clearinghouse server 104.

The administrative server 102 may have a network connection 122 through which an administrative console 124 and provisioning engine 126 may be accessed.

The administrative console 124 may be a mechanism through which an administrator may configure and manage remote services for various clients. In some embodiments, the administrative console 124 may have a web based administrative user interface through which an administrator may interface and operate the administrative server 102. In other embodiments, the administrative console 124 may have another type of application user interface.

The administrative console 124 may be an application that performs many of the general management functions and operations for managing remote services for various clients. For example, the administrative console 124 may establish a relationship with the clearinghouse server 104 and may receive information about available remote services. Such information may be stored in a remote services database 128.

The administrative console 124 may present a list of available remote services and enable an administrator to select one or more clients or managed entities that may access the remote services. The provisioning engine 126 may provision the managed entities by installing and configuring software and hardware, as well as providing credentials used for accessing the remote service.

The clearinghouse server 104 may provide many functions that may server to consolidate diverse remote services and enable the efficient management of those remote services. In many cases, the administrative server 102 may take advantage of the consolidation and enable efficient management of those services across multiple clients.

The clearinghouse server 104 may have a network connection 130 through which an administrative engine 132 may perform many various the consolidation and communication tasks.

The administrative engine 132 may perform various administrative functions. Administrative functions may include setting up accounts with various administrative servers, providing installation and configuration information to clients or administrative servers, and administering licensing, billing, and authentication services with clients or administrative servers.

The administrative engine 132 may establish accounts with administrative servers for the consolidated management of remote services. The accounts may be established for licensing, billing, and other administrative functions. The clearinghouse server 104 may consolidate the administrative functions from many different and diverse remote services into a single mechanism for the efficient administration and use of the remote services.

The administrative engine 132 may receive information about available remote services and provide the information to an administrative server 102. The information may include descriptions of the available remote services, and such information may be stored in a description database 134. The information may also include installation information that may be stored in an install database 136.

The administrative engine 132 may provide description and, in some cases, installation information to an administrative server 102 for storage in a local remote services database 128. In some embodiments, such information may be transmitted on a periodic basis to update the remote services database 128.

In some embodiments, an administrative server 102 may request description information from a clearinghouse server 104 each time such information is used. In some such embodiments, the administrative server 102 may not keep a local copy of the remote services database 128. Such embodiments may be useful when the amount of data that may be transmitted at each request may be relatively small.

The clearinghouse server 104 may establish accounts with various administrative servers. Each embodiment may have configurations and capabilities in an account, such as licensing, billing, authentication, proxy, and other administration capabilities.

A clearinghouse server 104 may have a licensing engine 138 through which a consolidated license agreement may be made between the clearinghouse server 104 and an administrative server 102. The clearinghouse server 104 may have individual license arrangements between the clearinghouse server 104 and each of the remote services 118 and 120, and each license arrangement may have different terms and conditions. The licensing engine 138 may consolidate the license arrangements and enable a single license arrangement between the administrative server 102 and the clearinghouse server 104.

A clearinghouse server 104 may have a billing engine 140 that may consolidate payment for multiple remote services 118 and 120. The billing engine 140 may enable a single invoice to be issued to cover multiple clients accessing multiple remote services. The billing engine 140 may enable an operator of a clearinghouse server 104 to receive payment from the operator of an administrative server 102 and distribute payment to operators of the remote services 118 and 120 accessed by the clients 112, 114, and 116.

A credential engine 142 may be used by a clearinghouse server 104 to establish credentials that may be used to access the remote services 118 and 120. In some embodiments, the credential engine 142 may establish credentials that may be used to access the remote services 118 and 120 with or without using the proxy engine 146 of the clearinghouse server 104 as an intermediary.

In some embodiments, the credential engine 142 may transmit a mechanism to the provisioning engine 126 of the administrative server 102 that may enable the provisioning engine 126 to create or distribute credentials. In one such embodiment, the credential engine 142 may create a list of usernames and passwords that may be issued to each client. In another embodiment, the credential engine 142 may create a digital certificate that may be transferred to the provisioning engine 126. The provisioning engine 126 may create child certificates based on the certificate supplied by the credential engine 142. In still other embodiments, the credential engine 142 may create a specific set of credentials for each managed entity as each managed entity is provisioned.

The clearinghouse server 104 may have a remote services portal 144 through which new remote services may be added. The remote services portal 144 may receive various information about the new remote service, establish licensing arrangements, billing arrangements, and authentication and proxy configurations. Once the information is configured and installed, the new remote service may be advertised to various administrative servers and installed onto various clients.

The proxy engine 146 may perform different proxy functions to interface between a client and a remote service. The proxy functions may include authentication as well as translation and data manipulation.

As an authentication function, the proxy engine 146 may authenticate a client, then provide separate authentication to a requested remote service before the client may access the remote service.

As a translation and data manipulation proxy, the proxy engine 146 may process communications between a client and a remote service. The proxy engine 146 may accept incoming communication using one protocol and transmit the communication to the other party using a different protocol. In some cases, data may be reformatted or even analyzed and processed.

The remote services 118 and 120 may be any type of service that may be provided over a network. Web services are one example of such a service. A remote service may be an application, function, database, or any other type of operation.

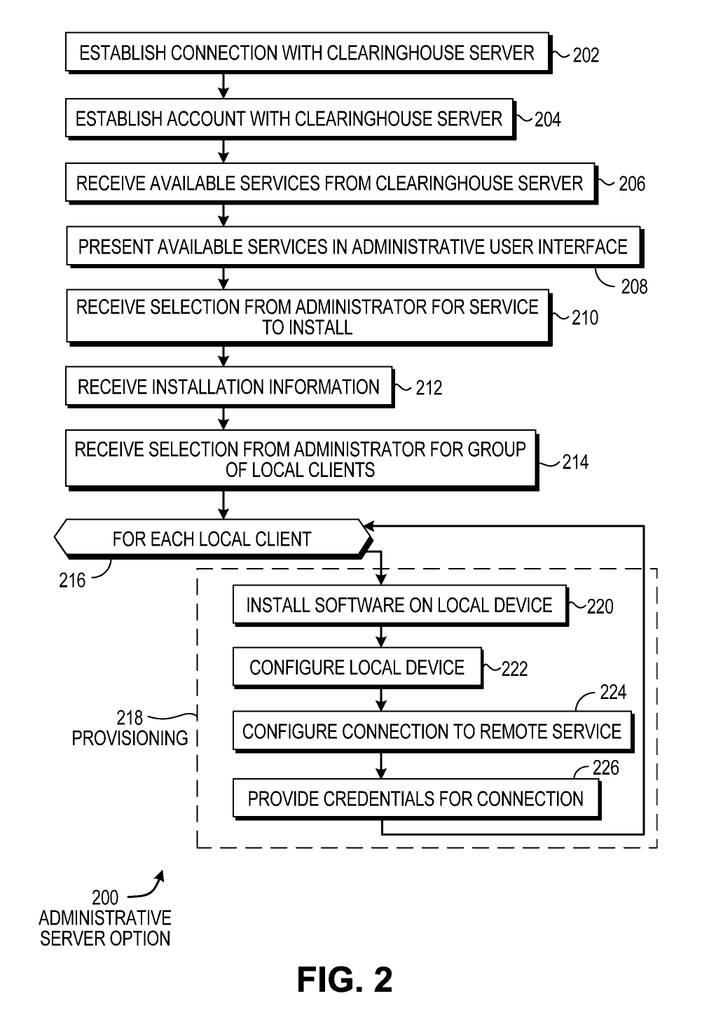

FIG. 2 is a flowchart illustration of an embodiment 200 showing a method that may be performed by an administrative server. Embodiment 200 is a simplified example of a process for establishing a connection with a clearinghouse server and configuring clients to access remote services.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Embodiment 200 is a simplified example of a method that may be performed by an administrative server. The administrative server may establish a relationship with a clearinghouse server, receive information regarding the available remote services, select a remote service, and configure a group of clients to access the remote service.

A connection may be established with the clearinghouse server in block 202 and an account may be established in block 204. The initial connection and account setup may comprise several steps, depending on the embodiment.

In a typical use scenario, an administrator or other user may install and configure an administrative console on a device that may be designated as an administrative server. The user may then establish a communication session with a clearinghouse server using a web interface, for example.

Depending on the embodiment, the user may be asked to establish an account with the clearinghouse server. During the account setup, a user may agree to certain license terms, select one or more packages of remote services to make available, and perform various administrative functions. One such function may be to establish a method of payment. Another function may also be to configure an authentication method, which may involve authenticating digitally signed certificates or installing various security related mechanisms.

A list of available remote services may be received from the clearinghouse server in block 206. In some embodiments, the data received in block 206 may be a subset of every available remote service, with the subset being defined during the account setup or based on other configuration parameters.

The available services may be presented in an administrative user interface in block 208. In many embodiments, the administrative user interface may be a web page or other application user interface.

An administrator may select one remote service to install in block 210 and may receive installation information in block 212. The installation information in block 212 may be any data, software, parameters, or other information that may be used to configure or provision a client to access the remote service.

In some embodiments, the clearinghouse server may transmit installation information along with the descriptions in block 206. In such an embodiment, an administrative server may store the installation information in a local database and retrieve the installation information in block 212.

In other embodiments, block 212 may involve a query to the clearinghouse server requesting the installation information. In such an embodiment, the administrative server may receive the installation information at the time the information is about to be used.

An administrator may select one or more clients, and the selection may be received in block 214. The group of clients may be selected to receive access to the remote service. The clients may include specific devices or groups of devices and/or specific users or groups of users for which access may be granted.

For each local client in block 216, a provisioning process may be performed in block 218. Each embodiment may have different provisioning techniques, and the provisioning process for one remote service may be different from another remote service. Similarly, one device or user may have one provisioning process while another user or device may use different software, steps, and configuration settings for a provisioning process.

The provisioning process of block 218 may include installing software on a local device in block 220. The software of block 220 may be an application or other service, function, script, or executable that may be used in accessing the remote service.

The provisioning process of block 218 may also include configuring the local device in block 222. In some embodiments, a local device may have settings such as application settings or other parameters that may be set or configured to work with the remote service. In some cases, the software installed in block 220 may be configured in block 222.

The connection to the remote service may be configured in block 224 for the local device as part of the provisioning process of block 218. A connection may be configured by setting protocols, addresses, and other communication parameters.

Credentials may be provided for the local device in block 226 as part of the provisioning process of block 218. The credentials may be stored on a local device and may be transmitted to the remote service or the clearinghouse server in order to initiate an authenticated session to access the remote service.

The provisioning process of block 218 may be performed in different manners depending on whether access to a remote service is provided on a user basis or a device basis. When access is provided on a user basis, software may be installed on various devices that may be accessed by a permitted user, but the various parameters and settings may be allocated for the permitted user and may not be available to users that are not permitted access.

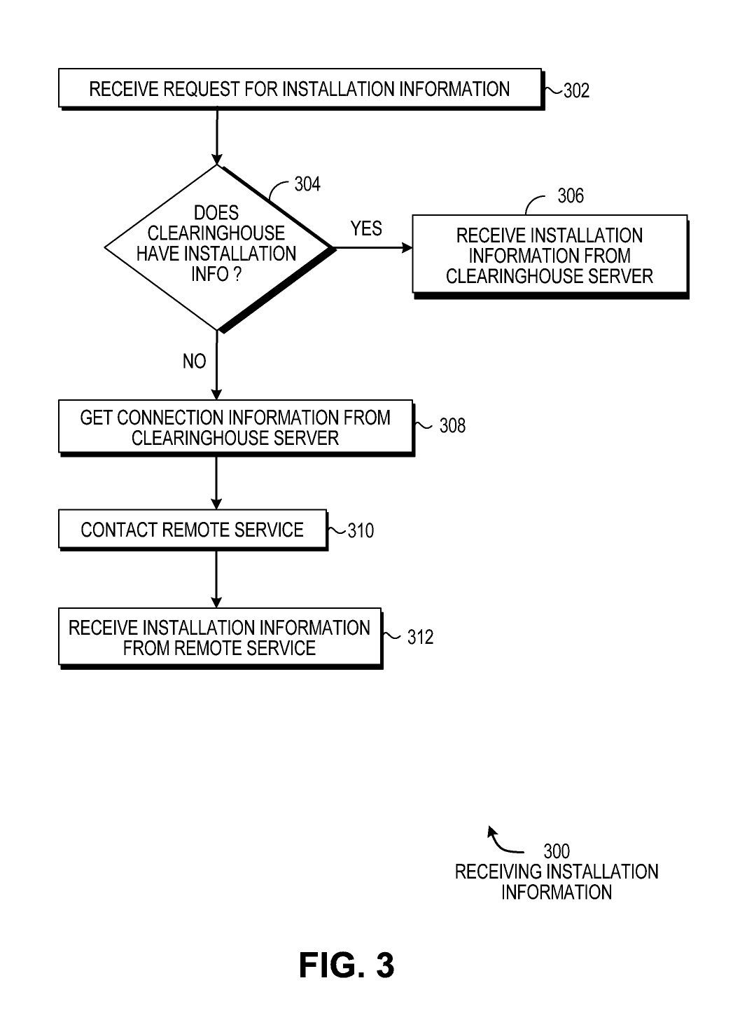

FIG. 3 is a flowchart illustration of an embodiment 300 showing a method for receiving installation information. Embodiment 300 is an expanded example of a process that may be performed in block 212 of embodiment 200.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Embodiment 300 is an example of a process that may be used for gathering installation information. In some cases, installation information may be provided through a clearinghouse server, while in other cases installation information may be obtained from a remote service. The process of embodiment 300 may be followed when an administrative server has selected a remote service for installation.

The installation information may include software, configuration settings, authentication mechanisms, protocol settings, or any other data that may be used for provisioning a client. In some cases, executable software, scripts, batch files, and other operable computer code may be included in the installation information. Such operable computer code may be executed by an administrative server or may be executed by a client device during installation or use of the remote service.

A request may be received for installation information in block 302.

If the clearinghouse server has the installation information in block 304, the installation information may be received from the clearinghouse server in block 306. An administrative server may receive installation information from a clearinghouse server a priori. In one such method, installation information may be received from a clearinghouse server along with descriptions of the available remote services, such as in block 206 of embodiment 200.

An administrative server may receive installation information from a clearinghouse server after a selection has been made to install a specific remote service. In such a case, the administrative server may send a query to the clearinghouse server requesting installation information. The clearinghouse server may respond with the information that is received in block 306.

If the clearinghouse server does not have the installation information in block 304, a connection to the clearinghouse server may be made in block 308 to obtain connection information to the remote service. A connection may be made to the remote service in block 310, and the installation information may be received from the remote service in block 312.

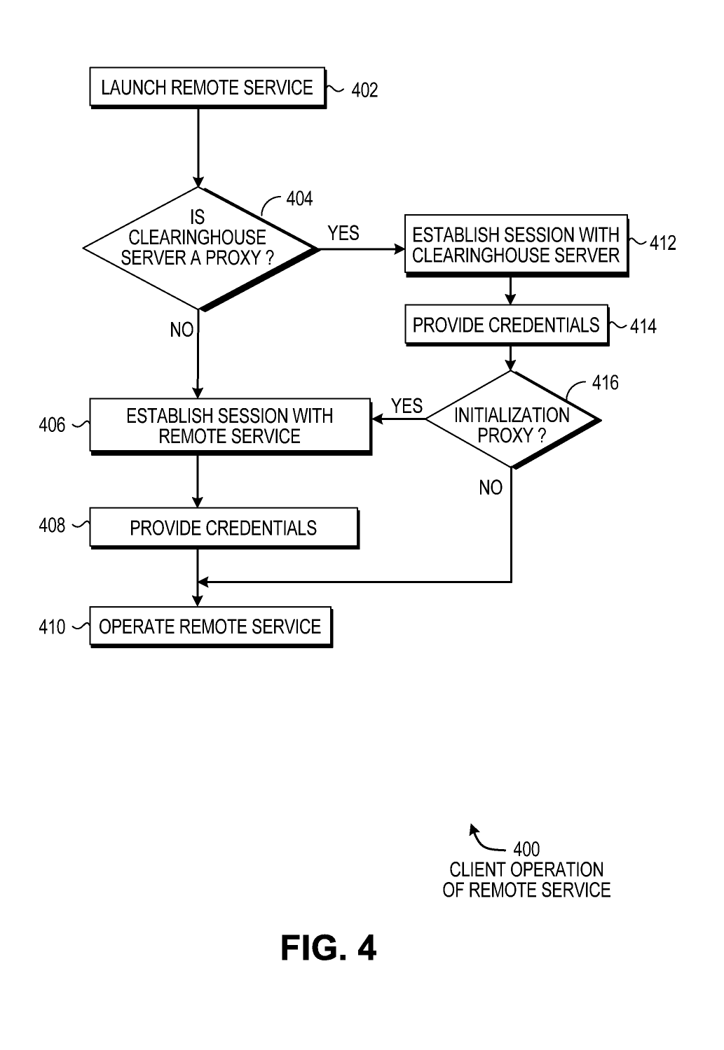

FIG. 4 is a flowchart illustration of an embodiment 400 showing a method for operating a remote service by a client. Embodiment 400 is a simplified example of the operations that may be performed by a client device in order to setup and connect to a remote service.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Embodiment 400 is an example of how a client device may connect to a remote service. In some cases, a clearinghouse server may provide some proxy services, including authentication proxy as well as communication proxy services. In other cases, a client may be capable of authenticating and communicating with the remote service without a clearinghouse server as a proxy.

A client may launch a remote service in block 402. In many embodiments, a user on a client device may select the remote service or an application that calls the remote service and cause the launch of block 402 to take place. In some embodiments, an application or service operating on a client device may cause the launch to occur without user interaction.

In some embodiments, a clearinghouse server may launch the remote service in block 402. In such an embodiment, the clearinghouse server may initiate the connections between the client and remote service, then enable the client and remote service to communicate back and forth with or without the clearinghouse server.

An example of such an embodiment may be a backup service. In the example, a clearinghouse server may initiate a periodic backup of a client, establish the connection between the client and backup service as a remote service, then allow the backup service and client to communicate independently of the clearinghouse server.

If the clearinghouse server is not a proxy in block 404, a session may be established with the remote service in block 406. The client device may provide credentials in block 408 and may operate the remote service in block 410.

In some embodiments, the credentials in block 408 may be credentials for a specific device or may be for a specific user. In some embodiments, the credentials of block 408 may include device-specific credentials as well as user-specific credentials.

If the clearinghouse server is a proxy in block 404, a session may be established between a client and the clearinghouse server in block 412. The client may supply credentials to the clearinghouse server in block 414.

When credentials are supplied to the clearinghouse server in block 414, the clearinghouse server may authenticate the client rather than the remote service. In such an embodiment, the clearinghouse server may provide authentication in cases where the remote service cannot provide authentication or where the remote service does not support a specific type of authentication supported by the client.

In some embodiments, the clearinghouse server may provide authentication in cases where the authentication is part of a billing or licensing arrangement. For example, a client may authenticate with a clearinghouse server prior to accessing a remote service so that the clearinghouse server may log the usage in a billing mechanism or may permit or deny access based on a licensing agreement made between an administrative server and the clearinghouse server.

If the clearinghouse server acts as an initialization proxy in block 416, the clearinghouse server may transfer the session or forward a session request to the remote service so that a session may be established in block 406 between the client and remote service. An initialization proxy may refer to a function of a clearinghouse server where the clearinghouse server provides some consolidated functions during the initialization of a connection between a client and a remote service.

If the clearinghouse server is not just an initialization proxy in block 416, the clearinghouse server may establish a session with the remote service and may forward communications between the client and remote service. In some embodiments, the clearinghouse server may translate, modify, log, or provide other processing to the communications between the client and remote service. Such embodiments may be useful when the communication protocols of a remote service are incompatible with those of a client device.

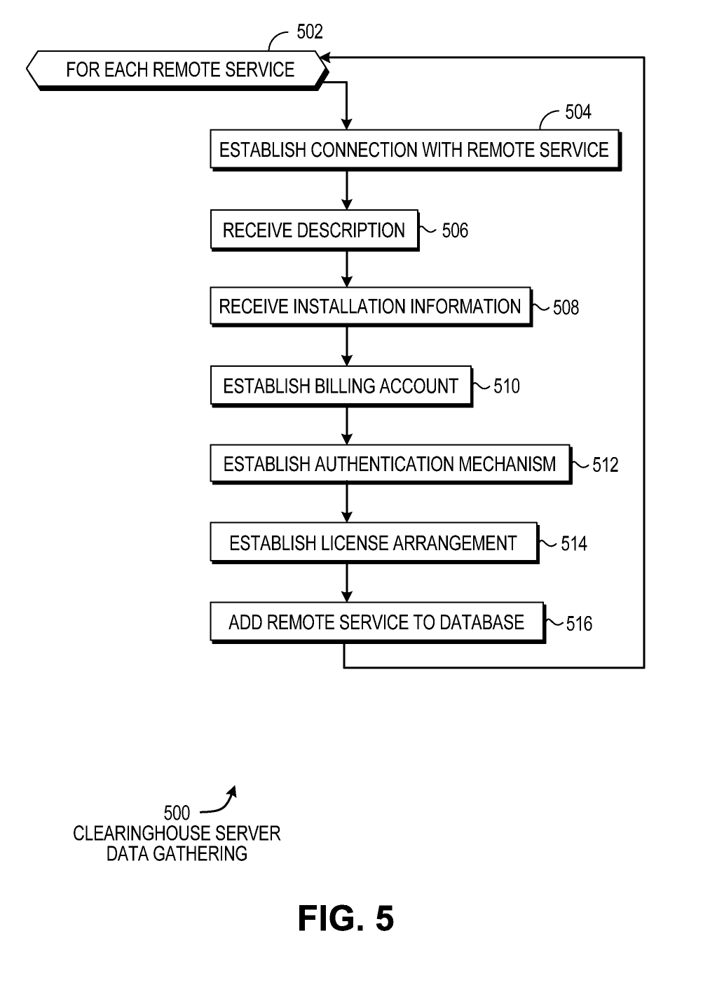

FIG. 5 is a flowchart illustration of an embodiment 500 showing a method that may be performed by a clearinghouse server for gathering information from remote services. Embodiment 500 is a simplified example of the data gathering and setup operations that may be performed prior to a remote service being made available through a clearinghouse server.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Embodiment 500 is an example of some of the steps that may be used to register or otherwise prepare a remote service for a clearinghouse server. The steps of embodiment 500 may enable a clearinghouse server to establish various services and functions that may be made available to a client device as well as to an administrative server. The method of embodiment 500 may be performed by a remote services portal 144 of embodiment 100.

For each remote service in block 502, several operations may be performed. Each embodiment may perform some or all of the steps, and some embodiments may include additional operations.

A connection may be made with a remote service in block 504. In some cases, the connection in block 504 may be made to an administrator, operator, or provider of a remote service to gather the remaining information or perform the following steps.

A description of the remote service may be received in block 506. The description may include any level of detail about the remote service, from a simple name of the remote service to a detailed, multi-paragraph description. In some cases, the description may include web addresses, illustrations, logos, or other information that may be presented through an administrative console of an administrative server.

Installation information may be received in block 508. In some embodiments, the installation information in block 508 may include a determination of how an installation process may be performed. For example, the installation information in block 508 may include a selection of several installation options. The options may include enabling a client device or administrative server to download installation information at the time of installation. Another option may be to provide some information through the clearinghouse server and additional information from an installation server associated with the remote service. Other options may also be included.

A billing account may be established in block 510. The billing account may include an agreement or arrangement for a cost schedule, methods of payment, discounts, or other billing related information.

An authentication mechanism may be established in block 512. As illustrated in embodiment 400, different sequences of authentication and use of credentials may be performed with different remote services. Some remote services may use authentication based on signed digital certificates. Other remote services may issue user identification and password credentials. Still other remote services may have different methods for authentication.

A license agreement may be established in block 514. The license agreement in block 514 may permit a clearinghouse server to resell the remote service or may have various other terms and conditions. In some cases, some or all of the license agreement of block 514 may be extended to the end user by way of an administrative server.

Once all the applicable data are obtained from the remote service, the remote service may be added to a clearinghouse database in block 516 so that the remote service may be made available to clients and administrative servers. In some embodiments, a clearinghouse server may add the remote service to a database as each portion of the embodiment 500 is performed. In other embodiments, the data may be added to the remote service in a single step after all of the data are collected.

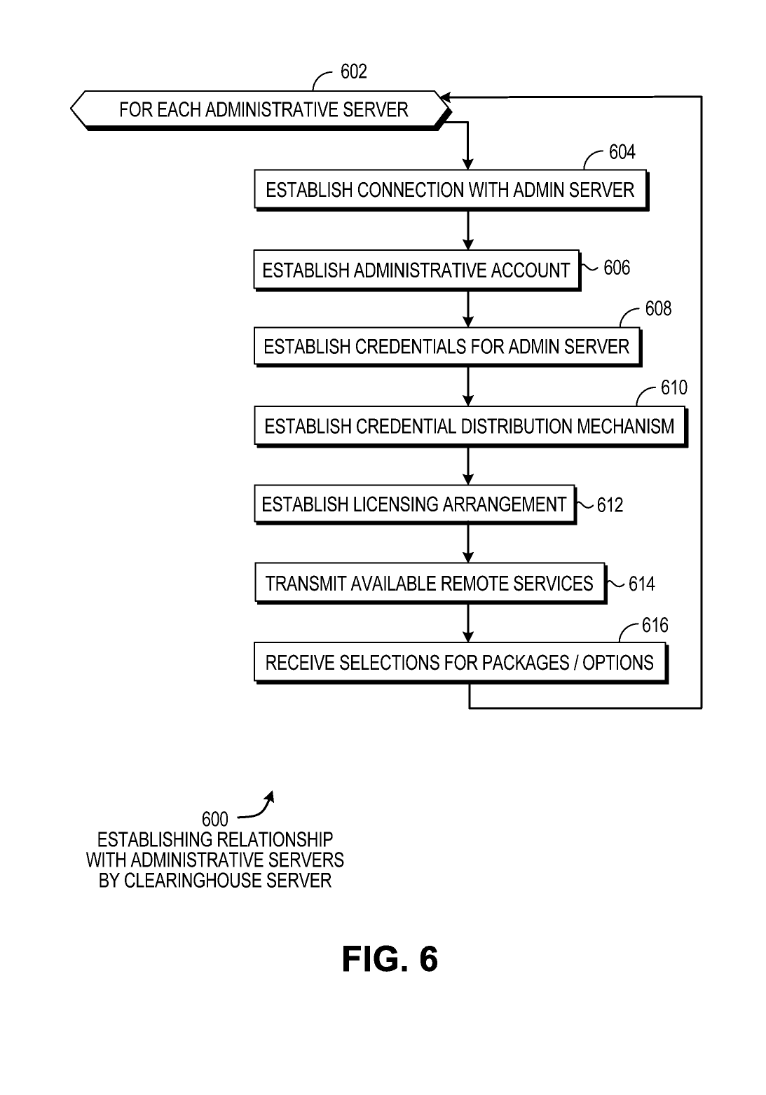

FIG. 6 is a flowchart illustration of an embodiment 600 showing a method that may be performed by a clearinghouse server for gathering information from administrative servers. Embodiment 600 is a simplified example of the data gathering and setup operations that may be performed prior to an administrative server being able to select and install a remote service on a client.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Embodiment 600 is an example of some steps that may be performed when an administrative server registers with and establishes a relationship with a clearinghouse server. Some embodiments may perform some or all of the illustrated steps, and some embodiments may include additional steps.

A connection may be established with an administrative server in block 604. In some embodiments, a client or managed entity may also serve as an administrative server.

An administrative account may be established in block 606. The administrative account may be a mechanism by which a user of an administrative server may perform various administrative tasks with the clearinghouse server. An example of such tasks may be to inquire about billing and configure various options, such as those options that may be set in blocks 608-616.

Credentials for an administrative server may be established in block 608. An example of such credentials may be a username and password. In some cases, PKI encryption certificates may be exchanged and validated or some other credentials may be exchanged. Some embodiments may use private keys or other credentials.

A credential distribution mechanism may be established in block 610. The credential distribution mechanism may enable an administrative server to create user-specific or device-specific credentials that may enable the user or device to access a remote service. In some embodiments, such a mechanism may not be installed or enabled on an administrative server.

A licensing arrangement may be established in block 612. The licensing arrangement may be an agreement between the user of the administrative server and the operator of the clearinghouse server with regard to the remote services accessed by a client. In some cases, the license arrangement of block 612 may include terms that are included in the license arrangement of block 514 of embodiment 500, which may be the license arrangement between the clearinghouse server and the remote services.

The clearinghouse server may transmit available remote services to the administrative server in block 614. The available remote services may be a complete list of all the remote services for which the clearinghouse server may aggregate. In some cases, the list of available remote services of block 614 may include those remote services that may be compatible with the agreements for billing, licensing, and authentication made in blocks 610, 612, and 614.

The clearinghouse server may present the available remote services in various packages. For example, a package of remote services may include various services that may be useful for specific types of users. In one such example, a package may be consolidated for accountants that include remote services for spreadsheets, word processors, and accounting programs. Another package may be presented for application developers that includes various development tools, editors, and code libraries.

A user of an administrative server may select various packages, options, or subsets of available remote services in block 616. Such selection may limit the list of available remote services that may be available for selection during the normal course of operation of an administrative server.

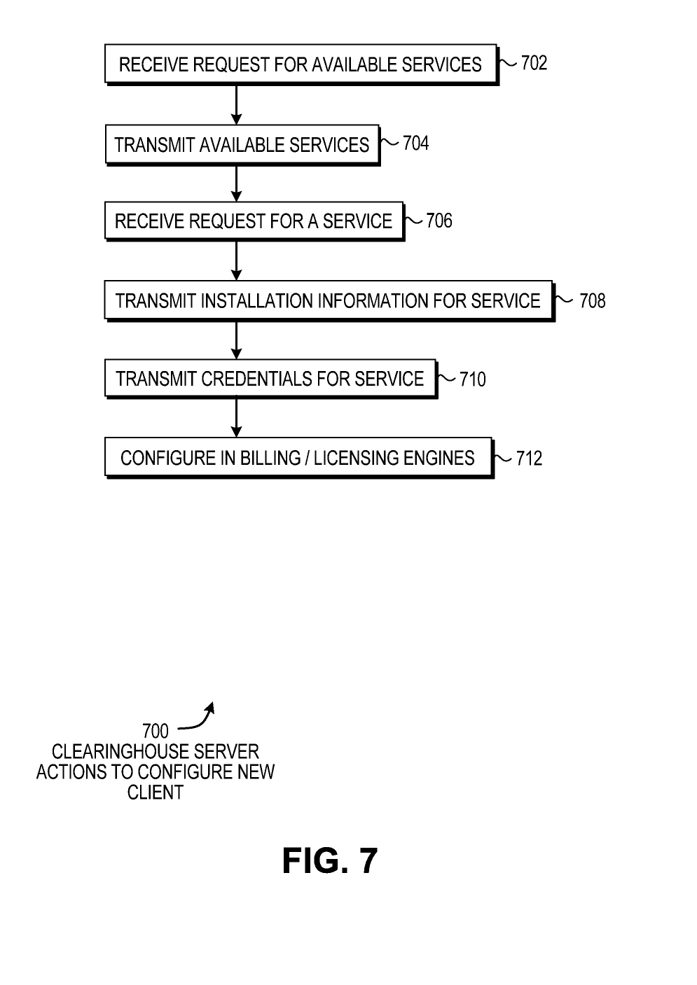

FIG. 7 is a flowchart illustration of an embodiment 700 showing a method that may be performed by a clearinghouse server when configuring a new client. Embodiment 700 is a simplified example of the steps that may be performed when an administrative server is performing the steps of embodiment 200.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

A request for available services may be received from an administrative server in block 702, and the available services may be transmitted in block 704. The available services may be transmitted as a list or set of descriptions of the services. In some cases, such a set of descriptions may be defined by packages of available remote services.

A request for a remote service may be received in block 706. A clearinghouse server may respond to the request of block 706 with installation information for the service in block 708. In some embodiments, the installation information may enable the administrative server or client to complete the installation without further involvement with the clearinghouse server. In other embodiments, the clearinghouse server may operate as a proxy for the remote services.

Credentials for the remote service may be provided in block 710. In some embodiments, a clearinghouse server may generate specific credentials for each individual user or device for which access may be permitted. In other embodiments, the administrative server may be capable of generating or granting such credentials.

The request for available services may be configured in the billing and licensing engines in block 712. In some cases, each managed entity may be separately logged and tracked in a clearinghouse billing and licensing mechanism. In other cases, an administrative server or the remote service may perform such logging and tracking.

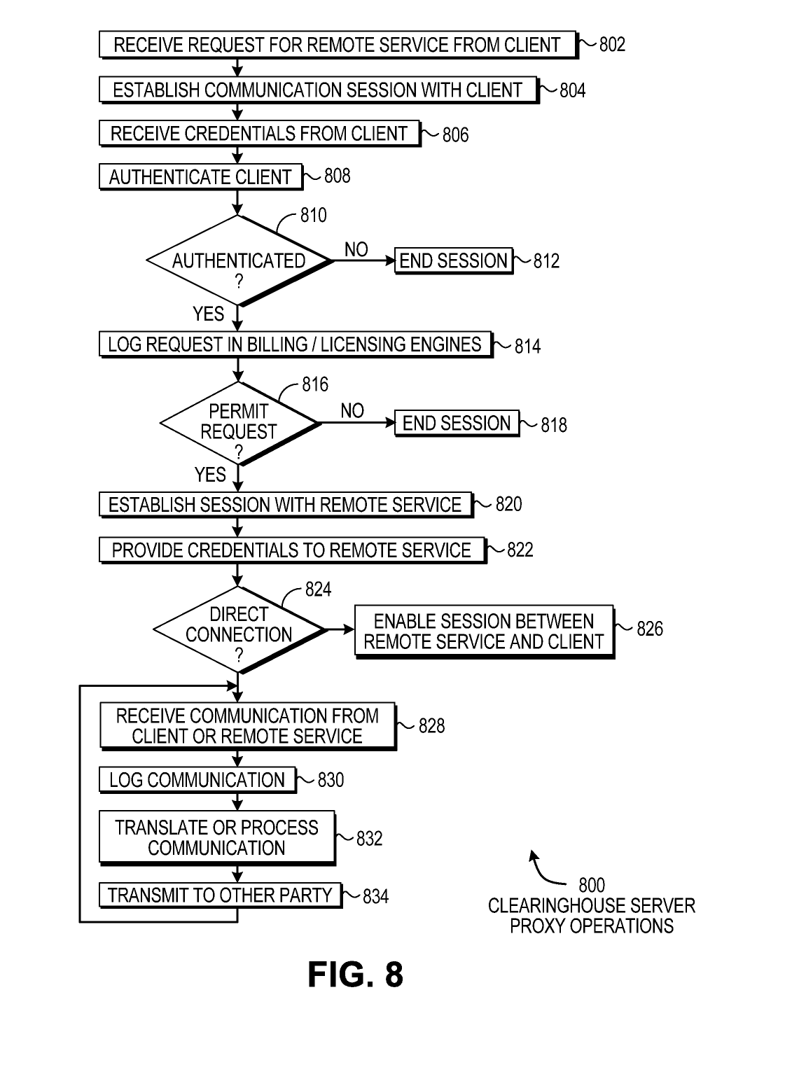

FIG. 8 is a flowchart illustration of an embodiment 800 showing a method that may be performed by a clearinghouse server for various proxy operations. Embodiment 800 is a simplified example of various proxy operations that may be performed. In some embodiments, one or more such proxy operations may be performed for different remote services.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

A request may be received from a client in block 802 for a remote service. When such a request is received, the client may be configured to connect to the clearinghouse server in order to access the remote service. The clearinghouse server may establish a communication session with the client in block 804 and receive credentials in block 806 in order to authenticate the client in block 808.

If the client is not properly authenticated in block 810, the session may be ended in block 812.

If the client is properly authenticated in block 810, the request may be logged in the appropriate billing and licensing engines in block 814.

If the request is not permitted in block 816 according to the billing and licensing engines, the session may be ended in block 818.

If the request is permitted by the billing and licensing engines in block 816, a session may be established in block 820 between the clearinghouse server and the remote service

The clearinghouse server may provide credentials to the remote service in block 822. The credentials supplied in block 822 may identify the client or may identify the clearinghouse server.

If a direct connection may be used between the client and remote service in block 824, a session between the remote service and the client may be established in block 826. Once the session is established in block 826, the client may use the remote service without going through the clearinghouse server for other operations.

If a direct connection is not used in block 824, the clearinghouse server may act as a communication proxy between the remote service and the client. The clearinghouse service established an authenticated session with the client in blocks 804, 806, and 808, as well as an authenticated session with the remote service in blocks 820 and 822.

Communication may be received from either the client or remote service in block 828. The communication may be logged in block 830, translated or processed in block 832, and transmitted to the other party in block 834.

The operations of blocks 828, 830, 832, and 834 may represent how a clearinghouse server may operate as a proxy between a client and a remote service. In some embodiments, the proxy operation may be as simple as redirecting a communication. In other embodiments, the proxy operation may involve translating the communication using different protocols or translation mechanisms.

The foregoing description of the subject matter has been presented for purposes of illustration and description. It is not intended to be exhaustive or to limit the subject matter to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments except insofar as limited by the prior art.

What is claimed is:

1. A method comprising:
presenting a plurality of remote services on an administrative user interface;
receiving a selection from said administrative user interface for a first remote service being selected from said plurality of remote services;
defining a set of manageable entities within a local area network; and
making said remote service available to said set of manageable entities.

2. The method of claim 1 further comprising:
receiving descriptions of said plurality of remote services from a clearinghouse server, said descriptions comprising a provisioning mechanism for said manageable entity.

3. The method of claim 1, said making said remote service available comprising:
provisioning said remote service to said manageable entity.

4. The method of claim 1, said making said remote service available comprising:
providing a connection mechanism through a clearinghouse service between said manageable entity and said remote service.

5. The method of claim 1, said making said remote service available comprising:
providing a set of credentials for said manageable entity.

6. The method of claim 5, said set of credentials being provided by a clearinghouse server.

7. The method of claim 1, said manageable entity comprising a device.

8. The method of claim 1, said manageable entity comprising a user.

9. A system comprising:
a connection to a plurality of manageable entities within a local area network;
an administrative user interface; and
a provisioning engine configured to:
present a plurality of remote services through said administrative user interface;
receive a selection from said administrative user interface for a first remote service being selected from said plurality of remote services;
define a set of said manageable entities for installing said first remote service; and
make said remote service available to said set of manageable entities.

10. The system of claim 9 further comprising:
a connection to a clearinghouse server, said clearinghouse server comprising a description and installation mechanism for each of said plurality of remote services.

11. The system of claim 10, said provisioning engine further configured to:
receive authentication credentials from said clearinghouse server; and
provide at least a portion of said authentication credentials to said manageable entity so that said manageable entity may access said remote server.

12. The system of claim 10, said manageable entities comprising users.

13. The system of claim 10, said manageable entities comprising devices.

14. A clearinghouse server comprising:
a database comprising descriptions and installation mechanisms for a plurality of remote services;
an administrative engine configured to receive requests for said descriptions and for said installation mechanism and transmit responses to said requests; and
a credential engine configured to create a set of credentials that may enable a user to access at least one of said plurality of remote services.

15. The clearinghouse server of claim 14, said administrative engine being further configured to:
receive a first communication from a client to a first remote service; and
transmit a second communication to said first remote service, said second communication being related to said first communication.

16. The clearinghouse server of claim 15,
said first communication being a request for a session between said client and said first service,
said clearinghouse service further comprised to authenticate said client prior to transmitting said second communication.

17. The clearinghouse server of claim 16, said session being between said client and said first service.

18. The clearinghouse server of claim 16, said session comprising a first session between said client and said clearinghouse server and a second session between said clearinghouse server and said first service.

19. The clearinghouse server of claim 14 further comprising a billing engine configured to:
establish a first account to a first remote service and a second account with a second remote service;
establish a third account with a client, said third account being a consolidation of at least a portion of said first account and said second account.

20. The clearinghouse server of claim 14 further comprising a web services portal configured to:
receive a new web service information;
add one of said descriptions to said database;
add one of said installation mechanisms to said database; and
make said new web service available through said administrative engine.
